(19) United States
(12) Patent Application Publication
(10) Pub. No.: US 2016/0328949 A1
(43) Pub. Date: Nov. 10, 2016

(54) Method for an Automated Distress Alert System with Speech Recognition

(71) Applicant: Victoria Zhong, Renton, WA (US)

(72) Inventor: Victoria Zhong, Renton, WA (US)

(21) Appl. No.: 14/705,501

(22) Filed: May 6, 2015

(51) Int. Cl. G08B 25/00; G10L 15/08; G10L 25/48; G10L 15/26

(52) U.S. Cl. CPC G08B 25/001; G10L 15/26; G10L 15/08; G10L 25/48; G10L 2015/088

(57) ABSTRACT

A software application for an automated alert system that utilizes speech recognition software to determine the emergency status of a person and respond accordingly. The software application includes monitoring ambient noise through a microphone for an utterance. Once an utterance is identified, it is recorded into an audio signal and fed into a speech-to-text software. The speech-to-text software converts the audio signal into a corresponding text. The corresponding text is then compares against a preconfigured plurality of distress passphrases in order to identify a positive match. Each of the plurality of distress passphrases is associated with an at least one type of alarm. If a positive match is identified for a specific distress passphrase, the software application triggers the type of alarm associated with the specific passphrase. If no match is found, the system continues to monitor the ambient noise and repeat the process for each utterance that is spoken.

### FIELD OF THE INVENTION

The present invention relates generally to an automated emergency notification system. More specifically, the present invention is a method for an automated alert system that utilizes speech recognition software to analyze passphrase and voice-based interaction to determine emergency status of a person and thus signal for help in a variety of means.

### BACKGROUND OF THE INVENTION

Humans can often find themselves in emergency situations where they require the assistance of other humans. Such situations may include a fall, a fire, strong-arm robbery, assault, car-jacking, abductions, and home invasions. Calling for assistance can be difficult in certain situations such as when the person requiring assistance may be alone or out of shouting range from other people. Additionally, the person requiring assistance may not be able to call for help due to threats of violence such as is case in a person-on-person assault. With the cost of computers and computer-based devices becoming affordable, technology can be used to provide assistance in such situations.

Devices have been invented that let people press a button and request help directly or after speaking to another person over two-way radio communications. However, requiring a button to be pressed means the device has to be within the proximity of the person requesting help. Furthermore, the act of overtly calling for help can bring danger if an assailant is in a position to threaten the victim. The majority of solutions to this problem require the person to request for assistance via communicating with a monitoring center, either overtly or covertly. However, communications with monitor centers require available communications channels and monitoring centers which tend to increase cost of the device itself.

Speech recognition is used in a wide variety of applications including dictation, interactive voice response systems, search engines, commanding devices and systems such as video games. However, while speech recognition can translate spoken words to their textual or token counterparts, it is not feasible to connect simple commands to actions taken by the system due to the lack of context such systems have. In other words, connecting the recognition of the word “help” to calling “911” will result in too many false alert cases where help is not required, especially if the system is always on. Therefore such a system would be impractical. Many speech-controlled systems therefore require the user to speak a key word to trigger semantic parsing of the following commands. For example, a user may utter the phrase “TV: turn on!” While the combination of “TV” and “turn on” can reduce the number of false positives from just using the words “turn on”, it is still not sufficient for use by a system that is designed to call for help.

Rule-based automated systems are used in a variety of applications. Such systems can emulate portions of human-to-human interactivity. For example integrated voice response systems can answer phones and perform a variety of transactions including directing the caller to a human operator. The next best thing to a real person coming to a person in distress is an automated system that is able to detect the emergency condition and render aid to the person in distress.

The present invention is a method and a system for providing automated assistance to a person in distress. The system can use a microphones and automated agent software to detect an emergency situation. The system also has a speaker and audio-producing software to communicate with the user to verify the emergency status or to let the user cancel the emergency status.

The present invention uses text-to-speech or pre-recorded audio clips to determine emergency situations through the identification of preset duress passphrases. If the user speaks the duress passphrase, the system can sound an audible alert and/or signal a home security system if one is installed. The user can also configure multiple passphrases for overt or covert requests for assistance.

Emergency situations, by their nature, are rare and thus users may not remember their duress passphrase or passphrases. Therefore, the present invention offers the user the ability to practice saying the duress passphrase and report successful or failed recognition of the passphrase. Additionally, the system can report statistics to the user regarding the number of near matches in a past window of time in order to inform the user the likelihood that the duress passphrase can be triggered accidentally. The system may also offer verbal greetings to make the user feel comfortable with interacting with said system. Speaker-independent speech recognition is more robust in recognizing more variations of each spoken word but is also more prone to falsely recognizing individual words than a speaker-independent speech recognition system for the same set of words. However, speaker-dependent speech recognition may not recognize a user's voice commands when the user is in a state of duress which causes the user's voice to be strained.

### BRIEF DESCRIPTION OF THE DRAWINGS

FIG. 1 is a flow chart of the overall process of the present invention.

FIG. 2 is a flow chart depicting the audible alarm feature of the present invention.

FIG. 3 is a flow chart depicting the illumination sequence feature of the present invention.

FIG. 4 is a flow chart depicting the silent alarm feature of the present invention.

FIG. 5 is a flow chart depicting the practice mode feature of the present invention.

### DETAIL DESCRIPTIONS OF THE INVENTION

All illustrations of the drawings are for the purpose of describing selected versions of the present invention and are not intended to limit the scope of the present invention.

The present invention is an automated emergency response system. The present invention uses speech recognition software in conjunction with at least one microphone to continuously monitor ambient noise for a preconfigured emergency passphrase to be spoken and upon detection, respond accordingly. Two preferred ways that the present invention may respond includes sounding an audible alarm and sending an alert signal to emergency responders and or a list of emergency contacts. Alternative actions may also be taken by the present invention. The system may be implemented in a variety of environments and locations such homes, stores, banks, and offices where people are going about their daily routine. Since any emergency response system, by nature, should only be triggered in an emergency situation, the present invention provides the user a variety of functions to help the user select an emergency passphrase which minimizes the chance that the emergency passphrase is accidentally recognized.

The present invention is a software application executed by a computing device to follow a computer-executable process in order to detect emergency situations and signal for help accordingly. Computing devices includes, but are not limited to, servers, smartphones, cellular phones, personal digital assistants, laptops, tables, personal computers, and other similar devices. In order to follow the computer-executable process, the software application requires additional hardware components, software applications, and supplementary information. Additional hardware components include a microphone, an audible speaker, and a lighting system (Step A). The microphone allows the software application to record various sounds within a designated vicinity, area around the microphone, into an audio signal. The audible speaker allows the software application to sound an audible alarm in order to signal for help and act as an alert for nearby personnel. Additionally, the audible speaker allows the software application to convey pertinent information to the user during installation, trouble shooting, and practice mode. Furthermore, the microphone and audible speaker allow the user to interact with the software application in order to accomplish a variety of functions including initiating an alarm and configuring settings. The lighting system allows the software application to display an illumination pattern to act as a visual alarm. The number and type of microphones and audible speakers used for the present invention may vary depending on the location and environment that the present invention is implemented in. For example, if the present invention is implemented in a single bedroom than no more than two microphones would be needed to fully capture any sound produced in the room. More than two microphones and audible speakers would be necessary if the present invention is implemented in a populated area like an office setting or a convenience store.

Also, in order for the software application to follow the computer-executable process, the present invention requires a plurality of distress passphrases and a speech-to-text software engine (Step B). In addition, the present invention requires a plurality of contacts. The plurality of contacts is a list of personnel and emergency entities to whom the present invention sends the alert signal to. As such, each of the plurality of contacts includes the necessary information required to reach said contact by telecommunication. Necessary information includes, but is not limited to, phone numbers and email addresses. Examples of emergency entities are fire departments and police stations. The plurality of distress passphrases is a list of emergency passphrase set by the user. The plurality of distress passphrases is designed to signal to the present invention that they are in an emergency situation. Each passphrase from the plurality of distress passphrases consists a multitude of words, preferably more than five words, arranged in a specific sequence. The software application allows the user to create his/her own passphrase for the plurality of distress passphrases. Additionally, each of the plurality of distress passphrases is associated with an at least one type of alarm as different types of alarms are designed for different emergency situations. Emergency situations include, but are not limited to, fire, armed robbery, burglary, assault, car-jacking, abduction, and home invasion to name a few non-limiting examples. The speech-to-text software engine is used to convert the audio signal produced by the microphone into a textual counterpart. In general, the speech-to-text software translates spoken words into a corresponding text in order to identify one or more preset passphrases from the plurality of distress passphrases. Various speech-to-text software engines may be used for the present invention. Additionally, the present invention may utilize volatile and non-volatile memory.

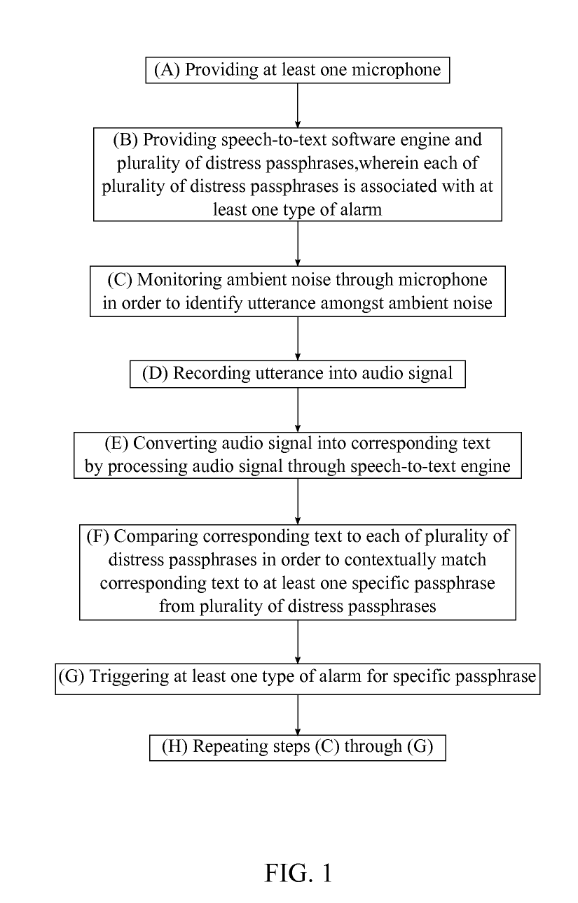

As can be seen in FIG. 1, the overall process of the present invention delineates the primary steps that need to be taken in order to identify an emergency situation and respond accordingly. The overall process begins by monitoring ambient noise through a microphone, which allows the present invention to identify an utterance amongst the ambient noise (Step C). The utterance is recoded into an audio signal when spoken out loud (Step D). The utterance may come from a variety of sources including different users, random strangers, television audio, and radio to name a few examples. Next, the software application converts the audio signal into a corresponding text by processing the audio signal through the speech-to-text engine (Step E). Once converted, the corresponding text is compared to each of the plurality of distress passphrases in order to contextually match the corresponding text to at least one specific passphrase from the plurality of distress passphrases (Step F). The degree of accuracy between the corresponding text and the specific passphrase may vary depending on initial settings and user preferences. If a match is identified between the corresponding text and the specific passphrase, the software application triggers the at least one type of alarm for the specific passphrase immediately (Step G). If no match is identified between the corresponding text and the specific passphrase, then the software application repeats steps (Step C) through (Step G) so that the software application is able to identify the next instant that the corresponding text contextually matches with the specific passphrase (Step H). Additionally, the software application continuously repeats steps (Step C) through (Step G) to ensure that the user may signal for help at any time of the day, week, month, or year.

The software application may also utilize a memory buffer process to continuously monitor a constant stream of spoken words. In one embodiment, the audio signal produced by the microphone is stored in the volatile memory as a memory buffer. The memory buffer is then passed to the speech-to-text software engine for processing. The software application stores the memory buffer and a certain amount of previous memory buffers while continuously performing a matching process (Step F), to the plurality of distress passphrases stored in the non-volatile memory. This prioritizes and controls the flow of data within the software application.

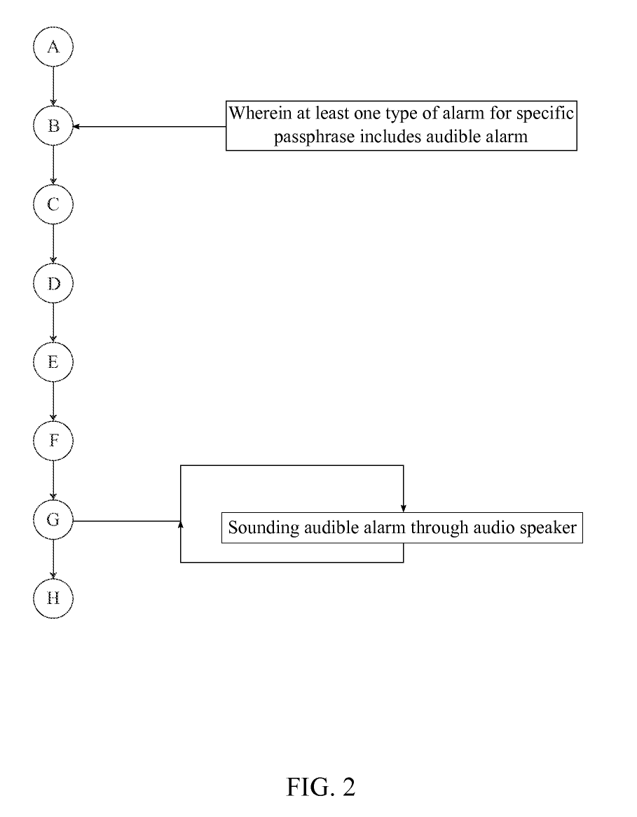

As mentioned above, each of the plurality of distress passphrases corresponds to an at least one type of alarm. The type of alarm dependents upon the type of emergency situation that the user is in. The type of alarm includes an audible alarm, a silent alarm, and an illumination sequence. The audible alarm is any auditory effect, preferably a tone or melody played at a high volume and high intensity. The audible alarm is designed to scare away or distract intruders or assailants as well as act as a signal to attract nearby personnel for aid. Various types of sounds and preconfigured recordings may be used for the audible alarm. For example, in case of burglary the audible alarm can be the phrase “Intruder Alert” being repeated a multitude of times with a horn sound played in the background. Referring to FIG. 2, if the at least one type of alarm for the specific passphrase includes the audible alarm, the software application sounds the audible alarm through the audio speaker as the present invention is able to match the corresponding text to the specific passphrase. The software application allows the user to configure the passphrases for the plurality of distress passphrase as well as setting the corresponding type of alarm for said passphrase. As a result, the user is able to customize the type of alarm that is triggered when said passphrase is spoken out loud.

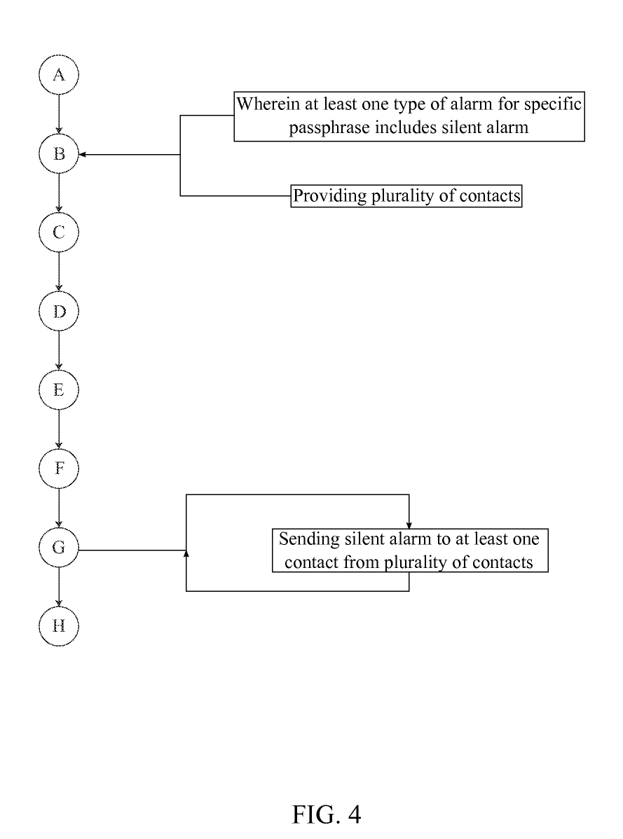

The silent alarm is a distress signal containing descriptive information relating to the user and the emergency situation associated with the identified specific passphrase, although the silent alarm can also include alternative information. The silent alarm is a means for contacting external assistance in certain emergency situations. Such emergency situations include, but are not limited to, fires, robbery, assault, and abduction. Referring to FIG. 4, if the at least one type of alarm for the specific passphrase includes a silent alarm, the software application sends the silent alarm to at least one contact from the plurality of contacts as the present invention is able to match the corresponding text to the specific passphrase. The software application may use a variety of telecommunication mediums in order to send the silent alarm. In one embodiment of the present invention, the software application is connected to a network interface that allows the software application to send the silent alarm over the Internet.

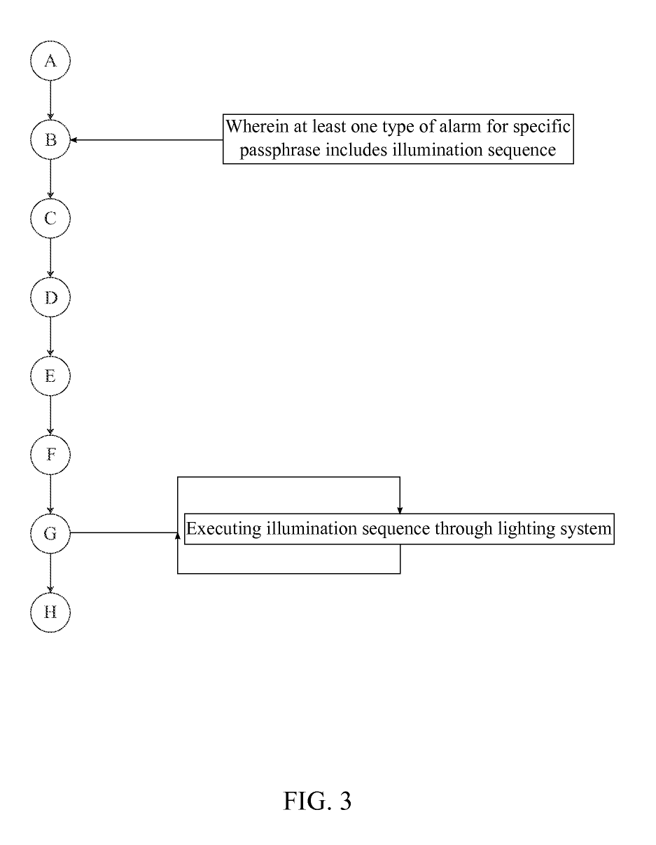

The illumination sequence is a visual affect signal. The illumination sequence signals nearby users and strangers about the emergency situation. The preferred illumination sequence is a bright and high frequency flashing as this is the most effective at obtaining someone's attention. This feature is useful for fires and situations alike. Referring to FIG. 3, if the at least one type of alarm for the specific passphrase includes an illumination sequence, the software application executes the illumination sequence through the lighting system as the present invention is able to match the corresponding text to the specific passphrase.

The listed types of alarms may be combined in any manner so as to cover a variety of emergency situations. In particular, more than one type of alarm may be associated with a single passphrase from the plurality of distress passphrases. For example, if the emergency situation is a fire the user would need to trigger the silent alarm to signal for help, trigger the audible alarm to alert nearby personnel and anyone within the building, and trigger the lighting sequence to signal any personnel with limited hearing limits. In this scenario, the specific passphrase for this particular emergency situation would correspond with the audible alarm, silent alarm, and the illumination sequence such that all three alarms are triggered once the specific passphrase is identified by the software application.

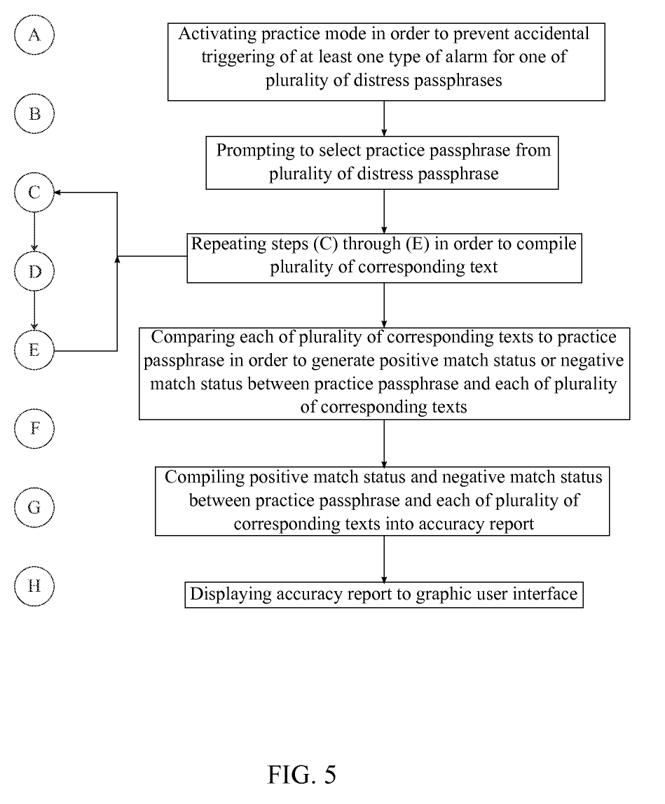

The present invention may be implemented within proximity of speech sources such as televisions, radios, and telephone conversations, and therefore must be robust against false detection of distress passphrases from the plurality of distress passphrases. To prevent false detection, the present invention includes a practice mode feature. The practice mode allows users to test each of the plurality of distress passphrases without triggering any alarm. The practice mode may be activated through a password passphrase or through the computing device. The process for the practice mode is depicted in FIG. 5. For this feature, the user first activates the practice mode in order to prevent an accidental triggering of the at least one type of alarm. Next, the software application prompts the user to select a practice passphrase from the plurality of passphrases, preferably through the computing device. The user then repeats the practice passphrase a multitude of times within the vicinity of the microphone. The software application executes (Step C) through (Step E) each time the user repeats the practice passphrase in order to compile a plurality of corresponding texts. The software application then compares each of the plurality of corresponding texts to the chosen practice passphrase in order to generate a positive match status or a negative match status between the practice passphrase and each of the plurality of corresponding texts. A positive match status indicates a significant similarity between the spoken practice passphrase and the corresponding distress passphrase from the plurality of distress passphrases stored by the software application. Alternatively, the negative match status indicates a significant different between the spoken practice passphrase and the corresponding distress passphrase from the plurality of distress passphrases stored by the software application. The software application then compiles the positive match status and the negative match status between the practice passphrase and each of the plurality of corresponding texts into an accuracy report. This accuracy report is then displayed to a graphic user interface, a monitor for instance, for the user to view and analyze. In one embodiment of the present invention, the software application can also report the number of near matches to let the user know how close the user was so that he/she can adjust accordingly. In another embodiment, the present invention may provide the user with instant feedback by sounding “success” or “fail” as well as allowing the user to repeat the practice passphrase. The software application may generate voice signals to interact with the user as well.

During the installation process, the software application also instructs the user(s) to choose a distress passphrase for the plurality of distress passphrase that contains five or more words such that the likelihood of such sequence of words being uttered by anyone around the vicinity of the present invention being rare or non-existent. This raises the threshold by which the distress passphrase must surpass before being identified as a positive match by the software application. An example of a distress passphrase is “The sky has never turned green before”. Another example is “The sky is always red on mars and Saturn”. Long distress passphrases or long sequences are hard to remember, especially if they are seldom used. It can be months, years, or decades before the user may require the need to utter the distress passphrase and henceforth may not remember the distress passphrase. The practice mode allows the user to remind himself or herself of the distress passphrases.

In one embodiment of the present invention, the software application may be integrated to work with pre-installed home security systems. The software application may be configured to trigger the home security system instead or in addition to the at least one type of alarm.

Although the invention has been explained in relation to its preferred embodiment, it is to be understood that many other possible modifications and variations can be made without departing from the spirit and scope of the invention as hereinafter claimed.

1. A method for an automated distress alert system with speech recognition by executing computer-executable instructions stored on a non-transitory computer-readable medium, the method comprises the steps of:
(A) providing at least one microphone;
(B) providing a speech-to-text software engine and a plurality of distress passphrases, wherein each of the plurality of distress passphrases is associated with at least one type of alarm;
(C) monitoring ambient noise through the microphone in order to identify an utterance amongst the ambient noise;
(D) recording the utterance into an audio signal;
(E) converting the audio signal into a corresponding text by processing the audio signal through the speech-to-text engine;
(F) comparing the corresponding text to each of the plurality of distress passphrases in order to contextually match the corresponding text to at least one specific passphrase from the plurality of distress passphrases;
(G) triggering the at least one type of alarm for the specific passphrase; and
(H) repeating steps (C) through (G).

2. The method for an automated distress alert system with speech recognition by executing computer-executable instructions stored on a non-transitory computer-readable medium, the method as claimed in claim 1 comprises the steps of:
wherein the at least one type of alarm for the specific passphrase includes an audible alarm; and
sounding the audible alarm through an audio speaker during step (G).

3. The method for an automated distress alert system with speech recognition by executing computer-executable instructions stored on a non-transitory computer-readable medium, the method as claimed in claim 1 comprises the steps of:
wherein the at least one type of alarm for the specific passphrase includes an illumination sequence; and
executing the illumination sequence through a lighting system during step (G).

4. The method for an automated distress alert system with speech recognition by executing computer-executable instructions stored on a non-transitory computer-readable medium, the method as claimed in claim 1 comprises the steps of:
wherein the at least one type of alarm for the specific passphrase includes a silent alarm;
providing a plurality of contacts; and
sending the silent alarm to at least one contact from the plurality of contacts during step (G).

5. The method for an automated distress alert system with speech recognition by executing computer-executable instructions stored on a non-transitory computer-readable medium, the method as claimed in claim 1 comprises the steps of:
activating a practice mode in order to prevent an accidental triggering of the at least one type of alarm for one of the plurality of distress passphrases;
prompting to select a practice passphrase from the plurality of distress passphrase;
repeating steps (C) through (E) in order to compile a plurality of corresponding texts; and
comparing each of the plurality of corresponding texts to the practice passphrase in order to generate a positive match status or a negative match status between the practice passphrase and each of the plurality of corresponding texts.

6. The method for an automated distress alert system with speech recognition by executing computer-executable instructions stored on a non-transitory computer-readable medium, the method as claimed in claim 5 comprises the steps of:
compiling the positive match status and the negative match status between the practice passphrase and each of the plurality of corresponding texts into an accuracy report; and
displaying the accuracy report to a graphic user interface.
